(19) United States
(12) Patent Application Publication
(10) Pub. No.: US 2004/0001993 A1
(43) Pub. Date: Jan. 1, 2004

(54) Gas diffusion layer for fuel cells

(76) Inventors: Mark R. Kinkelaar, Glenmoore, PA (US); Andrew M. Thompson, West Chester, PA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/329,775

(22) Filed: Dec. 27, 2002

Related U.S. Application Data
(63) Continuation-in-part of application No. 10/185,723, filed on Jul. 1, 2002.
(60) Provisional application No. 60/392,034, filed on Jun. 28, 2002.

(51) Int. Cl. H01M 4/86

(52) U.S. Cl. 429/40

(57) ABSTRACT

A gas diffusion layer for a fuel cell is formed from a porous material, which porous material comprises a solid matrix and interconnected pores or interstices therethrough that has at least one external surface and internal surfaces, wherein at least a portion of the at least one external surface is coated with one or more layers of at least one electrically conductive material. The electrically conductive material preferably has a resistivity less than 20 ohm-cm. Exemplary electrically conductive materials used for coating are metals, such as nickel, gold, platinum, cobalt, chromium, copper, indium, aluminum, titanium, zirconium, metal alloys of such materials, salts of such materials, and mixtures thereof, and amorphous carbon or graphite. A single or a series of multiple discrete conductive coating layers may be applied to the foam strands using coating methods such as electroplating, electroless plating, plasma vapor deposition, sputtering, arc forming, dipping and painting.

### CROSS REFERENCE TO RELATED APPLICATIONS

The instant application claims the benefit of U.S. Provisional Patent Application No. 60/392,034, entitled “Gas Diffusion Layer for Fuel Cells”, filed on Jun. 28, 2002 by Kinkelaar and Thompson, the disclosure of which is herein incorporated by reference. The instant application is also a continuation-in-part application of U.S. Non-Provisional patent application Ser. No. 10/185,723, entitled “Capillarity Structures for Water and/or Fuel Management in Fuel Cells”, filed on Jul. 1, 2002, the disclosure of which is also herein incorporated by reference.

This invention relates to a gas diffusion layer suitable to be placed adjacent to a cathode to help deliver oxygen to a cathode and/or a gas diffusion layer suitable to be placed adjacent to an anode to help deliver hydrogen to an anode in polymer electrolyte or proton exchange membrane (PEM) fuel cells. A gas diffusion layer suitable for use in a fuel cell is also described in U.S. Provisional Patent Application No. _______, entitled “Gas Diffusion Layer Containing Electrically Conductive Polymer for Fuel Cells”, filed on Dec. 27, 2002 by Kinkelaar and Finkelshtain, the disclosure of which is also herein incorporated by reference.

### BACKGROUND OF THE INVENTION

In PEM fuel cells, positive ions within the membrane are mobile and free to carry positive charge through the membrane. Movement of hydrogen ions (protons) through the membrane from the anode to the cathode is essential to PEM fuel cell operation. The hydrogen ions (H⁺) pass through the membrane and combine with oxygen and electrons on the cathode side producing water. Electrons (e⁻) cannot pass through the membrane. Therefore, electrons collected at the anode flow through an external circuit driving an electric load that consumes the power generated by the cell and are distributed to the cathode. The product of the reaction at the cathode is water. The open circuit voltage from a single cell is about 1 to 1.2 volts. Several PEM fuel cells can be stacked in series to obtain greater voltage and membrane area can be increased to get more amperage

In PEM fuel cells, an oxidation half-reaction occurs at the anode, and a reduction half-reaction occurs at the cathode. In the oxidation half-reaction, gaseous hydrogen produces hydrogen ions and electrons, wherein the hydrogen ions travel through the proton conducting membrane to the cathode and the electrons travel through an external circuit to the cathode. In the reduction half-reaction, oxygen supplied from air flowing past the cathode combines with the hydrogen ions and electrons to form water and excess heat. Catalysts, such as platinum, are used on both the anode and cathode to increase the rates of each half-reaction. The final products of the overall cell reaction are electric power, water and heat. The fuel cell is cooled, usually to about 80° C. At this temperature, the water produced at the cathode is in both a liquid form and vapor form. The water in the vapor form is carried out of the fuel cell by air flow through a gas diffusion layer and flow fields or channels in a bipolar plate.

A typical PEM fuel cell structure 1 in the prior art is shown in FIG. 1 in exploded view. The membrane electrode assembly (“MEA”) 4 is comprised of a PEM 6 with an anode layer 5 adjacent one surface and a cathode layer 5A adjacent an opposite surface. Gas diffusion layers 3, 3A are positioned adjacent each electrode layer. Bipolar plates 2, 2A are positioned adjacent each gas diffusion layer 3, 3A. The bipolar plates generally are fabricated of a conductive material and have channels (or flow fields) 7 through which reactants and reaction by-products may flow. The adjacent layers of the fuel cell structure contact one another, but in FIG. 1 are shown separated from one another in exploded view for ease of understanding and explanation.

The polymer electrolyte or proton exchange membrane (PEM) is a solid, organic polymer, usually polyperfluorosulfonic acid, that comprises the inner core of the membrane electrode assembly (MEA). Commercially available polyperfluorosulfonic acids for use as PEMs are sold by E. I. DuPont de Nemours & Company under the trademark NAFION®. Alternative PEM structures are composites of porous polymeric membranes impregnated with perfluoro ion exchange polymers, such as offered by W. L. Gore & Associates, Inc.

A substantial amount of water is liberated at the cathode and must be removed so as to prevent flooding the cathode or blocking the gas flow channels in the bipolar plate, cutting off the oxygen supply and locally halting the reaction. In prior art fuel cells, air is flown past the cathode to carry all the water present at the cathode as vapor out of the fuel cell.

Prior art fuel cells incorporated porous carbon papers or cloths as gas diffusion layers or backing layers adjacent the PEM of the MEA. The porous carbon materials not only helped to diffuse reactant gases to the electrode catalyst sites, but also assisted in water management. Porous carbon paper was selected because carbon conducts the electrons exiting the anode and entering the cathode. However, porous carbon paper has not been found to be an effective material for directing excess water away from the cathode, and often a hydrophobic layer is added to the carbon paper to help with water removal. The carbon papers have limited flexibility, and tend to fail catastrophically when bent or dropped. Such papers cannot be supplied in a roll form, and, therefore, are less amenable to automated fabrication and assembly. They tend to be rigid and non-conforming, and are not compressible. Careful tolerances are required to maintain an intimate electrical contact between the MEA and the bipolar plate via the carbon paper. And porous carbon papers are expensive. Consequently, the fuel cell industry continues to seek gas diffusion layers that will improve fuel delivery and by-product recovery and removal, maintain effective gas diffusion and effective conductive contact, and simplify the manufacturing of fuel cells without adversely impacting fuel cell performance or adding significant weight or expense.

Bipolar plates serve at least four functions in prior art fuel cells. First, bipolar plates deliver reactants (pure hydrogen or hydrogen gas mixtures) to the gas diffusion layer and ultimately over the surface of the anode. Second, bipolar plates distribute oxygen, air or other oxidant gases to the gas diffusion layer and ultimately over the surface of the cathode. Third, when fuel cells are stacked together, the bipolar plates collect and conduct electrons from the anode of one cell to the cathode of an adjacent cell. Fourth, the bipolar plates separate the reactants from any cooling fluids that may be used to cool the fuel cell.

To prevent the mixing of the hydrogen or hydrogen gas mixtures with oxygen, air or other oxidant gases, bipolar plates must be made of a gas-impermeable material in order to separate the gaseous reactants of the anode and the adjacent cathode. Without effective separation by the bipolar plates, direct oxidation/reduction of the gaseous reactants of the anode and adjacent cathode would take place leading to inefficiency. Because the bipolar plates must conduct the electrons produced by the fuel cell reaction in a fuel cell stack, the material used to make the bipolar plates must be electrically conductive. Bipolar plates commonly are formed from machined graphite sheet, or carbon-carbon composites or metals, such as titanium. The bipolar plates thus contribute a significant weight to the fuel cell, which is a disadvantage particularly where the fuel cell is intended to be used for portable or mobile applications. Moreover, fabricating the bipolar plates from carbon-carbon composites or machined graphite sheets is expensive. Molded plates frequently have lower conductivity than machined plates. Carbon-based bipolar plates often have higher than desired porosity, which can lead to cross-contamination, so greater plate thicknesses are required. When metals are selected, the plates may be thinner due to minimal, if any, porosity of metals; however, metals still tend to add greater weight and must be carefully selected because the plates must not corrode or degrade in the fuel cell environment.

Prior art bipolar plates of foamed metals, such as foamed titanium, have several additional drawbacks. First, they are expensive to fabricate. Second, foamed metals with fine pore sizes are difficult to manufacture with known techniques. Third, the metal foams are rigid, and thus can be easily permanently bent or dented, making it difficult to maintain contact with the electrode layers of the MEA and/or the metal separator sheet. Fuel cells made with metal foams may require higher clamping pressure to maintain intimate contact. Fourth, as the foamed metals are cut to the desired size they form sharp corners, significantly increasing the risk that the MEA will be punctured during assembly.

One proposed fuel cell design constructs the bipolar plates with a combination of (a) a gas diffusion layer formed by perforated or foamed metal, and (b) metal separator sheets. The reactants flow through pores of the foamed metal or through slits formed in the perforated metal. The foamed metal has sponge-like structure with small voids or pores that take up more than 50% of the bulk volume of the material. The bipolar plate is formed from two pieces of foamed metal with a thin layer of solid metal in between (separator sheet). The fuel cell stack is formed from layers of (i) metal sheet, (ii) foamed metal, (iii) MEA, (iv) foamed metal, (v) metal sheet, (vi) foamed metal, (vii) MEA, (viii) foamed metal, (ix) metal sheet, . . . etc. J. Larminie and A. Dicks, Fuel Cell Systems Explained, (Wiley & Sons, England 2000), Chap. 4, p. 86. See also, U.S. Pat. No. 4,125,676.

Consequently, the fuel cell industry continues to seek improved fuel cell structures, particularly improved gas diffusion layers that will maintain effective gas diffusion and maintain effective current conductivity without adversely impacting fuel cell performance or adding significant thickness, weight or expense. The present invention is aimed at solving some of the problems associated with prior art gas diffusion layers and bipolar plates mentioned above by providing improved gas diffusion layers useful as gas diffusion layers per se or as components of bipolar plates.

### SUMMARY OF THE INVENTION

According to a first aspect of the invention, a gas diffusion layer for a fuel cell is formed from a porous material comprising a solid matrix and interconnected pores or interstices therethrough that has at least one external surface and internal surfaces, wherein at least a portion of the at least one external surface is coated with one or more layers of at least one electrically conductive material. The “internal surfaces” of the porous material are the surfaces of the walls of the pores or interstices.

The porous material of the gas diffusion layer of the present invention, preferably, has at least portions of some of the internal surfaces coated with one or more layers of at least one electrically conductive material in addition to at least a portion of the at least one external surface being coated with at least one electrically conductive material, with the coated portions of the internal surfaces and the coated portion of the at least one external surface together forming an electrically conductive pathway. The at least one electrically conductive material coating the at least portions of some of the internal surfaces may be the same as (preferred) or different from the at least one electrically conductive material coating the at least a portion of the at least one external surface.

If the porous material of the gas diffusion layer of the invention has two or more external surfaces, i.e. at least first and second external surfaces, it is also preferred that at least a portion of the first external surface and at least a portion of the second external surface are coated with one or more layers of at least one electrically conductive material, with the coated portions of the first and second external surfaces together forming an electrically conductive pathway. The at least one electrically conductive material coating the at least a portion of the first external surface may be the same as (preferred) or different from the at least one electrically conductive material coating the at least a portion of the second external surface. More preferably, in addition to at least portions of the first and second external surfaces being coated with at least one electrically conductive material, at least portions of some of the internal surfaces of the porous material are coated with one or more layers of at least one electrically conductive material, with the coated portions of the first and second external surfaces, as well as the coated portions of some of the internal surfaces, together forming an electrically conductive pathway. The at least one electrically conductive material coating the at least portions of some of the internal surfaces, the at least one electrically conductive material coating the at least a portion of the first external surface and the at least one electrically conductive material coating the at least a portion of the second external surface may be the same or different, preferably the same.

The gas diffusion layer of the present invention can be in the shape of a substantially rectangular or square sheet having six external surfaces: first and second major external surfaces opposite to each other and first, second, third and fourth minor external surfaces, wherein a portion of at least one of the major external surfaces is coated with one or more layers of at least one electrically conductive material. Preferably, at least a portion of at least the first major external surface and a portion of at least the first minor external surface are coated with one or more layers of at least one electrically conductive material, with the coated portion of the first major external surface and the coated portion of the first minor external surface together forming a electrically conductive pathway, wherein the at least one electrically conductive material coating the first major external surface and that coating the first minor external surface are the same (preferred) or different. More preferably, at least a portion of at least the first major external surface, at least a portion of at least the second major external surface and at least a portion of the first minor external surface are coated with one or more layers of at least one electrically conductive material, with the coated portion of the first major external surface, the coated portion of the second major external surface and the coated portion of the first minor external surface together forming a electrically conductive pathway, wherein the at least one electrically conductive material coating the first major external surface, that coating the second major external surface and that coating the first minor external surface are the same (preferred) or different. Also more preferably, at least a portion of at least the first major external surface, at least a portion of at least the second major external surface and at least portions of some of the internal surfaces are coated with one or more layers of at least one electrically conductive material, with the coated portion of the first major external surface, the coated portion of the second major external surface and the coated portions of some of the internal surfaces together forming a electrically conductive pathway, wherein the at least one electrically conductive material coating the first major external surface, that coating the second major external surface and that coating at least some of the external surfaces are the same (preferred) or different. In these embodiments of the gas diffusion layer, the first major external surface is in contact with an electrode when the gas diffusion layer is installed in a fuel cell, wherein the second major external surface is optionally in contact with a bipolar plate.

In the gas diffusion layer of the present invention, the external surface or one of the external surfaces of the porous material having at least a portion coated with the at least one electrically conductive material is useful as an external surface in contact with an electrode when the gas diffusion layer is installed in a fuel cell.

In the gas diffusion layer of the present invention, when at least a portion of an external surface of the porous material is coated with the at least one electrically conductive material, preferably that external surface is substantially entirely coated with the at least one electrically conductive material. The external surface being substantially entirely coated with the at least one electrically conductive material is especially suitable to be the external surface in contact with an electrode when the gas diffusion layer is installed in a fuel cell.

For instance, if the porous material is a flexible reticulated polymer foam, the porous material comprises a network of strands forming interstices therebetween, wherein at least a portion of the network of such strands at the surface of the porous material is coated with one or more layers of the at least one electrically conductive material. Preferably, at least a portion of the network of such strands at the surface of the porous material and at least a portion of the network of such strands inside the porous material are coated with one or more layers of the at least one electrically conductive material. Preferably, at least some of the strands on a surface of the gas diffusion layer that will come in contact with an electrode when installed in a fuel cell are coated with one or more layers of the at least one electrically conductive material. More preferably, in addition to at least some of the strands on the surface of the gas diffusion layer that will come in contact with the electrode being coated with the at least one electrically conductive material, at least some of the strands inside the gas diffusion layer are coated with one or more layers of the at least one electrically conductive material. Even more preferably, (i) at least some of the strands of the porous material at the surface of the gas diffusion layer that will come in contact with the electrode, (ii) at least some of the strands of the porous material inside the gas diffusion layer, and (iii) at least some of the strands of the porous material at a surface of the gas diffusion layer that will come in contact with a bipolar plate when the gas diffusion layer is installed in the fuel cell are coated with one or more layers of the at least one electrically conductive material to create an electrically conductive path from the electrode to the bipolar plate.

The porous material for the gas diffusion layer of the invention can be a porous polymeric material or porous inorganic material with the porous polymeric material preferred over the porous inorganic material. The porous polymeric material can be selected from foams, bundled fibers, matted fibers, needled fibers, woven or nonwoven fibers, porous polymers made by pressing polymer beads, Porex and Porex like polymers. The porous polymeric material preferably is selected from foams, bundled fibers, matted fibers, needled fibers, and woven or nonwoven fibers. More preferably, is the porous polymeric material is selected from polyurethane foams (preferably felted polyurethane foams, reticulated polyurethane foams, or felted reticulated polyurethane foams), melamine foams, polyvinyl alcohol foams, or nonwoven felts, woven fibers or bundles of fibers made of polyamide such as nylon, polyethylene, polypropylene, polyester such as polyethylene terephthalate, cellulose, modified cellulose such as Rayon, polyacrylonitrile, and mixtures thereof. The porous polymeric material is, further more preferably, a foam such as a polyurethane foam, e.g. felted polyurethane foam, reticulated polyurethane foam, or felted reticulated polyurethane foam. Even more preferably, the porous polymeric material is a reticulated polymer foam such as a reticulated polyurethane foam. Most preferably, the porous polymeric material is a flexible reticulated polyurethane foam. Certain inorganic porous materials, such as sintered inorganic powders of silica or alumina, can also be used as the porous material.

A reticulated foam is produced by removing the cell windows from the cellular polymer structure, leaving a network of strands and thereby increasing the fluid permeability of the resulting reticulated foam. Foams may be reticulated by in situ, chemical or thermal methods known to those of skill in foam production.

If a foam is used to form the gas diffusion layer of the invention, the foam can be a polyether polyurethane foam having a pore size in the range of about 5 to about 150 pores per linear inch, and a density in the range of about 0.5 to about 8.0 pounds per cubic foot prior to coating.

The porous material can be of any physical shape as long as it has at least one flat surface for making contact with one of the electrodes when the gas diffusion layer is installed in a fuel cell. Thus, when a foam, such as a flexible reticulated polyurethane foam, is used as the porous material, the foam can be of any physical shape when not compressed as long as the foam has at least one flat surface in a uncompressed state (e.g. a foam in the form of a sheet) or compressed state for making contact with an electrode when installed in a fuel cell.

Exemplary electrically conductive materials include carbon (e.g. amorphous carbon and graphite), electrically conductive polymers (e.g. polyacetylene, polyaniline, polypyrrole, polythiophene, polyethylenedioxythiophene, polyfuran, and poly(p-phenylene vinylene), with polyaniline, polypyrrole and polyethylenedioxythiophene being preferred), composites of electrically conductive polymers with graphite (e.g. polyaniline-graphite, polypyrrole-graphite or polyethylenedioxythiophen-graphite composites, with polyaniline-graphite composites being preferred), metals (e.g. nickel, gold, platinum, cobalt, chromium, copper, indium, aluminum, titanium and zirconium), alloys of such metals, salts of such metals, and mixtures thereof, such as a mixture of a metal and amorphous carbon or graphite. The at least one electrically conductive material, preferably, is selected from nickel, gold, platinum, cobalt, chromium, copper, indium, aluminum, titanium and zirconium, alloys of such metals, salts of such metals, and mixtures thereof, as well as mixtures thereof with amorphous carbon or graphite. Preferably, the at least one electrically conductive material has a resistivity less than 20 ohm-cm, most preferably less than 1 ohm-cm.

In this application, the term “coated” means intimately adhered to. When a portion of the at least one surface of the porous material is “coated” with an electrically conductive material, the electrically conductive material is intimately adhered to the portion of the at least one surface leaving substantially no gap between the solid matrix of the “coated” portion and the electrically conductive material. Therefore, when the surface of a porous material is “coated” with an electrically conductive material to make a gas diffusion layer according to the present invention, a porous material having a metal layer crimped onto the surface of the porous material is excluded. When a segment of a strand of the solid matrix of a porous material forming a gas diffusion layer of the present invention is “coated” with an electrically conductive material, substantially the entire external surface of the segment has the electrically conductive material intimately adhered thereto so that a cross-sectional view of the segment shows a core of the solid matrix surrounded by and directly in contact with a layer of the electrically conductive material (e.g. see FIG. 3).

The at least a portion of the surface or portions of the surfaces of the porous material may be coated with the at least one electrically conductive material using one or a combination of various coating methods, such as electroplating, electroless plating, plasma vapor deposition, sputtering, arc forming, a dip and nip coating process or by painting a surface or surfaces of the porous material with a paint or slurry formed from electrically conductive particles dispersed in a liquid binder. If a polyurethane foam is used as the porous material, the coated polyurethane foam retains compressibility, recoverability and flexibility. Sheets of such coated polyurethane foam can be looped onto a roll for ease of transport and dispensing. In one preferred embodiment, the paint or slurry is formed with electrically conductive carbon powder dispersed in a liquid binder. The paint or slurry can also be formed with a metal powder dispersed in a liquid binder.

Mixtures of electrically conductive coating materials (e.g. a mixture of nickel and amorphous carbon or graphite) may be used to coat the at least a portion of the surface or portions of the surfaces of the porous material to form the gas diffusion layer of the present invention. In addition, two or more layers of the same or different electrically conductive materials may be applied to coat the same portion(s) of the surface(s).

In the gas diffusion layer of the present invention, the one or more layers of the at least one electrically conductive material coating the portion(s) of the surface(s) of the porous material can have a total thickness of no more than about 1000, 500, 100, 50, 10, 5, 1 or 0.1 micron, or a total thickness of about 0.1-1000, 1-1000, 1-500, 5-100 or 10-50 microns.

The porous material forming the gas diffusion layer according to the present invention is preferably a foam, more preferably a polyether polyurethane foam, having a pore size in the range of about 5 to about 150 pores per linear inch, and a density in the range of about 0.5 to about 8.0 pounds per cubic foot before being coated with the at least one electrically conductive material.

In some of the embodiments of the gas diffusion layer of the invention, the porous material is a foam. Before being coated with the at least one electrically conductive material, the foam may be felted to increase its surface area by compressing the foam under heat and pressure to a desired thickness and compression ratio, which permanently deforms the foam. Compression ratios of about 1. 1 to about 10, e.g. 3, 4, 5 or 6, are preferred. For a compression ratio of 10, the foam is compressed to 1/10 of its original thickness.

Felting is carried out under applied heat and pressure to compress a foam structure to an increased firmness and reduced void volume. Once felted, the foam will not recover to its original thickness, but will remain compressed to a reduced thickness. Felted foams generally have a higher surface area per unit volume than unfelted foam, and improved capillarity and water holding than unfelted foams. Yet, felted foams still retain sufficient porosity to transmit gases therethrough. If a felted polyurethane foam (e.g. a felted flexible reticulated polyether polyurethane foam) is selected as the porous material for the gas diffusion layer, such foam should have a density in the range of about 2 to about 40 pounds per cubic foot after felting, and a compression ratio in the range of about 1.1 to about 10 (e.g. 3, 4, 5 or 6).

A second aspect of the invention is directed to a combination comprising a gas diffusion layer of the invention as described above adjacent to (preferably in contact with) an electrode (either a cathode or anode) for a fuel cell, wherein the electrode comprises at least one catalyst and an optional solid backing layer. The catalyst is for the oxidiation/reduction carried out in the fuel cell and can be platinum. In the combination, the at least one external surface of the porous material of the gas diffusion layer having at least a portion the external surface coated with the at least one electrically conductive material is adjacent to (preferably in contact with) the electrode. Within the scope of the second aspect of the invention is a method of making the combination, comprising the step of placing a gas diffusion layer of the invention in contact with a catalyst suitable for use in a fuel cell.

A third aspect of the invention is directed to a combination comprising a gas diffusion layer of the invention as described above adjacent to, preferably in contact with, a separator. The separator is a sheet of a substantially nonporous electrically conductive material, such as a metal. The separator may also be a nonporous bipolar plate formed from a metal, amorphous carbon or graphite. In the combination, an external surface of the porous material of the gas diffusion layer having at least a portion the external surface coated with one or more layers of at least one electrically lo conductive material can be adjacent to (preferably in contact with) the separator. The combination may further contain an electrode (either cathode or anode) of a fuel cell, with the electrode disposed adjacent to (preferably in contact with) the gas diffusion layer at a surface of the gas diffusion layer opposite to the separator, so the combination comprises three layers connected in the order of: separator, gas diffusion layer and the electrode, wherein the external surface of the gas diffusion layer having at least a portion coated with the at least one electrically conductive material is adjacent to (preferably in contact with) the electrode and the gas diffusion layer optionally has at least a portion of another external surface layer coated with one or more layers of at least one electrically conductive material with said another external surface adjacent to the separator.

A fourth aspect of the invention is directed to a PEM fuel cell having at least one gas diffusion layer of the invention installed. The fuel cell comprises a cathode supplied with a gaseous oxidant stream, an anode supplied with a gaseous stream containing hydrogen, a solid polymer electrolyte or proton exchange membrane (PEM) sandwiched between the cathode and anode, and at least one gas diffusion layer of the invention disposed adjacent to either the cathode or anode on a surface opposite the PEM. Preferably, two gas diffusion layers of the invention are provided in the fuel cell, with the first gas diffusion layer disposed adjacent to the cathode and the second gas diffusion layer disposed adjacent to the anode, wherein the corresponding gas diffusion layer is disposed on a surface of the respective electrode opposite the PEM. The first and second gas diffusion layers may be the same or different, and preferably each comprises a sheet of foam such as polyether polyurethane foam as the porous material. More preferably, each of the first and second gas diffusion layers comprises a sheet of flexible reticulated foam, e.g. flexible reticulated polyurethane foam, as the porous material. The porous materials forming the first and second gas diffusion layers preferably are polyether polyurethane foams that have a pore size in the range of about 5 to about 150 pores per linear inch, and a density in the range of about 0.5 to about 8.0 pounds per cubic foot before being coated with the at least one electrically conductive material.

The gas diffusion layer of the invention disposed adjacent to the cathode has a longest dimension. Preferably, the porous material, e.g. foam, in the cathode gas diffusion layer can wick water by capillary action and the water can subsequently be released from the porous material, wherein the porous material has a free rise wick height greater than at least one half of the longest dimension of the cathode gas diffusion layer. The porous material, more preferably, has a free rise wick height greater than at least the longest dimension of the cathode gas diffusion layer. The gas diffusion layer adjacent to the cathode can be in liquid communication with a liquid drawing means for drawing the water previously wicked into the cathode gas diffusion layer out of the fuel cell. The liquid drawing means is preferably a pump. The wicking action of the porous material, e.g. foam, in the gas diffusion layer adjacent to the cathode helps in removing water from the cathode to prevent flooding of the cathode.

Preferably, a separator is positioned adjacent to the first gas diffusion layer. The separator is a thin sheet of a substantially nonporous conductive material, such as a metal. The separator may also be a bipolar plate formed from a metal, amorphous carbon or graphite as known to persons skilled in the art. Most preferably, a separator is also positioned adjacent to the second gas diffusion layer.

### BRIEF DESCRIPTION OF THE DRAWINGS

FIG. 1 is a schematic view in side elevation of a fuel cell according to the prior art that has two carbon fabric gas diffusion layers between the MEA and bipolar plates;

FIG. 2 is a schematic view, in side elevation of a fuel cell according to the invention that has two compressible coated foam gas diffusion layers between the MEA and the bipolar plates;

FIG. 3 is a schematic view in cross-section of a coated foam strand from one of the gas diffusion layers of FIG. 2;

FIG. 4 is a graph of applied force versus strain showing the results of three-point bending tests conducted on samples according to the invention and samples from the prior art; and

FIG. 5 is a graph showing stress versus strain hysteresis for metallized nickel foam according to the prior art as compared with a compressible coated foam according to the invention.

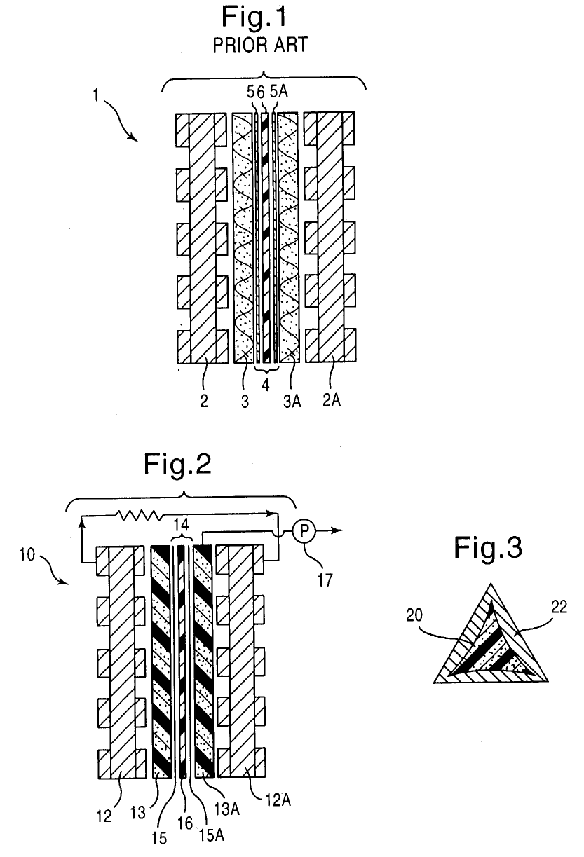

### DESCRIPTION OF THE PREFERRED EMBODIMENTS

Referring first to FIG. 2, a fuel cell 10 includes a membrane electrode assembly (“MEA”) 14 comprising a polymer electrolyte membrane (“PEM”) 16 sandwiched between an anode 15 and a cathode 15A. The PEM 16 is a solid, organic polymer, usually a polyperfluorosulfonic acid, that comprises the inner core of the membrane electrode assembly (MEA). Catalyst layers (not shown) are present on each side of the PEM. The PEM must be hydrated to function properly as a proton (hydrogen ion) exchanger and as an electrolyte.

Adjacent to the anode 15 is provided a gas diffusion layer 13 formed from a 7 mm or less thick sheet of 85 pore reticulated polyether polyurethane foam that is covered by a coat 22 of an electrically conductive material. See also FIG. 3. The gas diffusion layer 13 helps to distribute a source of hydrogen uniformly to the anode 15. It also collects electrons from the anode and provides a path for electron flow from the anode through a load 30 to the cathode 15A. Adjacent to each gas diffusion layer 13, 13A are bipolar plates 12, 12A.

Optionally, a separator (not shown) formed from an electrically conductive material compatible with the conductive material coating the gas diffusion layer may be provided adjacent to the gas diffusion layer along with or in place of each bipolar plate 12, 12A. Adjacent to the cathode 15A is provided a second gas diffusion layer 13A formed from a 7 mm or less thick sheet of 85 pore reticulated polyether polyurethane foam that has been coated with a conductive material. The second gas diffusion layer 13A helps to remove water from the cathode side of the fuel cell to prevent flooding, and allows air or other desired gaseous oxygen source to contact the cathode side to ensure oxygen continues to reach the active sites. The second gas diffusion layer 13A has a longest dimension. The second gas diffusion layer 13A preferably wicks the water from the cathode by capillary action, wherein the foam of the second gas diffusion layer has a free rise wick height greater than at least the longest dimension. Optionally, the second gas diffusion layer 13A is in liquid communication with a pump 17, which draws the water previously wicked into the second gas diffusion layer out of the second gas diffusion layer in order to move the water out of the fuel cell. The second gas diffusion layer 13A will transmit electrons completing the circuit between the anode and cathode.

In practice, each fuel cell component is position in contact with the adjacent components. FIG. 2 is presented in an exploded view and shows the components in spaced relation for ease of understanding.

In operation, a hydrogen source (gaseous such as hydrogen gas, or vapor such as methanol or water vapor) reacts at the surface of the anode 15 to liberate hydrogen ions (H⁺) and electrons (e⁻). The hydrogen ions (H⁺) pass through the PEM 16 membrane and combine with oxygen and electrons on the cathode 15A side producing water. Electrons (e⁻) cannot pass through the membrane 16 and flow from the anode 15 to the cathode 15A through an external circuit containing an electric load 30 that consumes the power generated by the cell. The reaction product at the cathode is water (H₂O). The PEM fuel cell operates at temperatures generally from 0° C. to 80° C., and the liberated water most often is in vapor form.

The gas diffusion layers 13, 13A according to the invention have a thickness in the range of 0.1 to 10 mm, preferably 7 mm or less, more preferably from 0.2 to 4.0 mm, and most preferably less than about 2.0 mm.

The gas diffusion layers 13, 13A are formed from polyurethane foam, felted polyurethane foam, reticulated polyurethane foam, and felted reticulated polyurethane foam. A particularly preferred gas diffusion layer is formed from a flexible reticulated polyether polyurethane foam having a density in the range of 0.5 to 8.0 pounds per cubic foot and a pore size in the range of 5 to 150 pores per linear inch, preferably greater than 70 pores per linear inch, e.g. about 85 pores per linear inch, before coating. Flexible polyurethane foams well suited for use as gas diffusion layers should rebound following compression and bend in a 3 inch loop without failing catastrophically (e.g. cracking, tearing, deforming, and taking a permanent set).

Referring to FIG. 3, the electrically conductive material 22 is coated onto the strands 20 of polyurethane foam to form a gas diffusion layer. The coating intimately surrounds each strut or strand in the cellular polyurethane network. Preferably the coating is a metal including nickel, gold, platinum, cobalt, chromium, copper, indium, aluminum, titanium, zirconium, metal alloys of such materials, salts of such materials, such as zirconium nitride or titanium nitride, and mixtures thereof. The coating may also contain amorphous carbon or graphite. The conductive coating may be applied using various methods known to those of skill in the art, including electroplating, electroless plating, plasma vapor deposition, sputtering and arc forming. The coating may be applied by dipping or by painting, and the coating might be a conductive carbon coating or a paint or slurry formed as a liquid having conductive particles dispersed therein. In a dipping and nipping coating process, the foam is first dipped in a coating liquid and then compressed in the nip formed between two compression platens or rollers to squeeze the coating liquid through the foam and cause excess coating liquid to be expelled from the foam.

A protective pre-coating of a non-conductive polymer may also be applied to the foam strands before the conductive coating is applied. Such pre-coatings may include acrylics, vinyls, natural or synthetic rubbers, or similar materials, and may be applied using a water borne or organic solvent borne coating process, such as dipping, or painting, optionally followed by nipping.

The electrically conductive coating applied to the strands of the polyurethane foam to form the gas diffusion layer should have a resistivity less than 20 ohm-cm, preferably less than 1 ohm-cm. The gas diffusion layer must be capable of collecting and conducting the current from the anode for use in a load and return to the cathode. In a fuel cell stack, the gas diffusion layer conducts the current from the anode of one fuel cell to the cathode of an adjacent fuel cell.

Significant advantages of the gas diffusion layers according to the invention are compressibility, flexibility, and ease of handling. The gas diffusion layers readily conform to the space into which they are installed. The foams rebound after compression such that good contact may be maintained between the gas diffusion layer and the surface of the respective anode or cathode that is adjacent to the gas diffusion layer. Improved contact means greater efficiency in current transfer. Moreover, lo because the gas diffusion layers according to the invention are made with flexible and compressible foams, they do not have the drawbacks associated with perforated or foamed metals, which can puncture the MEA and deform when handled during fuel cell assembly. The flexible and compressible gas diffusion layers of the present invention also have advantages over traditional carbon papers, which papers are fragile and only available in flat sheet form, making them less amenable to automated assembly.

### EXAMPLE 1

A 70 pore per linear inch reticulated polyether polyurethane foam was prepared from the following ingredients:

| | | |
|---|---|---|
| Arcol 3020 polyol (from Bayer Corp.) | 100 | parts |
| Water | 4.7 | parts |
| Dabco NEM (from Air Products) | 1.0 | part |
| A-1 (from OSi Specialties/Crompton) | 0.1 | parts |
| Dabco T-9 (from Air Products) | 0.17 | parts |
| L-620 (from OSi Specialties/Crompton) | 1.3 | parts |

After mixing the above ingredients for 60 seconds and allowing the mixed ingredients to degas for 30 seconds, 60 parts of toluene diisocyanate were added. This mixture was mixed for 10 seconds and then placed in a 15″ by 15″ by 5″ box to rise and cure for 24 hours. The resulting foam had a density of of 1.4 pounds per cubic foot. After peeling the foam into a sheet having a thickness of one-eighth of an inch, the foam strands were coated using electroless plating techniques with a first layer of copper and then with a second layer of nickel. The total combined coating thickness was estimated to be 24 micro-inches. The resultant coated foam had the following properties:

| | |
|---|---|
| Resistivity | less than 0.5 ohm-cm |
| Void volume | approximately 97% |
| Air permeability | 0.125 ft³ of air per ft² of foam per min |
| Compressibility | Full recovery after 90% deflection |

Able to make a 3 inch loop without failure

### EXAMPLE 2

An 88 pore per linear inch polyurethane foam was felted to firmness 6 (compressed to one-sixth of its original thickness) with a final thickness of 2 mm. The felted foam was perforated with 113 one-millimeter diameter holes per square inch, with a total perforated void volume of 18%. The felted and perforated foam was coated via electroless plating first with a thin layer of copper, followed by a thin layer of nickel. The total coating thickness was estimated to be 40 micro-inches. The resultant coated foam had the following properties:

| | |
|---|---|
| Resistivity | less than 0.5 ohm-cm |
| Void Volume | approximately 82% |
| Air Permeability | 108 ft³ of air per ft² of foam per min |
| Compressibility | Full recovery after 50% compression |

Able to make a 3 inch loop without failure

Able to make a 3 inch loop without failure

### EXAMPLE 3

An 88 pore per linear inch reticulated polyurethane foam was felted to a firmness of 8 (compressed to one-eighth of its original thickness) with a final thickness of 0.8 mm. The felted foam was coated with a conductive carbon/binder (40/60) system to a coating weight of 200% pick up (final coated product weight=3× the uncoated foam weight, per sq ft). The resultant foam had the following properties:

| | |
|---|---|
| Resistivity | 20 ohm-cm |
| Void volume | approximately 65% |
| Air permeability | 43 ft³ of air per ft² of foam per min |
| Compressibility | Full recovery after 50% compression |

### EXAMPLE 4

An 88 pore per linear inch reticulated polyurethane foam was felted to a firmness of 4 with a final thickness of 0.8 mm. The foam strands were coated using electroless plating techniques with a layer of nickel. The total combined coating thickness was estimated to be about 40 micro-inches. The resultant coated foam had the following properties:

| | |
|---|---|
| Resistivity | 0.52 ohm-cm |
| Void volume | approximately 85% |
| Air permeability | 150 ft³ of air per ft² of foam per min |
| Compressibility | Full recovery after 90% compression |

Three-point bending tests were conducted comparing the nickel coated reticulated foam of Example 4 according to the invention with prior art carbon papers, carbon cloths and nickel metal foam. The testing samples included:

| | |
|---|---|
| A. | Spectracorp 2050A-2020 carbon paper (0.51 mm thick); |
| B. | Toray-060 (plain) carbon paper (0.17 mm thick) |
| C. | Toray-120 (plain) carbon paper (0.35 mm thick) |
| D. | Knit weave carbon cloth (1 mm thick) |
| E. | Nickel metal foam (˜2 mm thick) |
| F. | Example 4 coated reticulated foam (0.8 mm thick) |
| G. | Carbon cloth, plain weave (0.65 mm thick), and |
| H. | Carbon cloth satin weave(1.0 mm thick) |

All carbon cloth samples were purchased from E-TEK, a division of DeNora N.A., in Somerset, N.J.

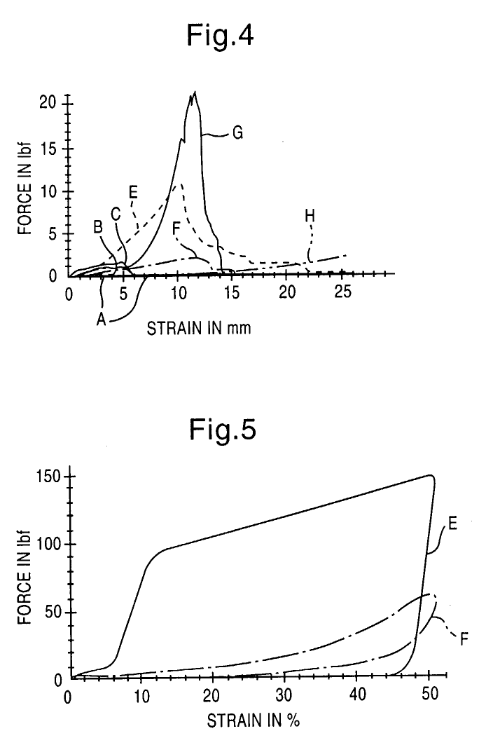

The three point bending test measures the force applied to strain or deflect the material until failure. The apparatus consisted of two 0.75 inch beams separated by a 0.75 inch gap. Each sample was separately attached to both beams so as to bridge the gap between the beams. A 0.25 inch diameter probe was forced into the sample held between the beams. For each amount of incremental force applied to the sample through the probe, the deflection in the sample was measured until the sample failed (broke apart or slipped in the fixture). The results of the three point bending test for each of the samples A.-H. are shown in the stress-strain curves in FIG. 4. The carbon papers (A.-C.) failed after a bending strain of 4 to 6 mm; these papers are brittle and easily break under applied force. Next was the nickel metal foam (E.), which broke after a 10 mm deflection. The Example 4 coated reticulated foam (F.) did not fail but slipped in the fixture demonstrating greater bending strength, which means better handling than the carbon papers or nickel metal foam. One of the carbon cloths (H.) slipped in the fixture at 25.5 mm, which was a greater bending strength than foam F. However, carbon cloths also are the highest cost materials for gas diffusion layers.

Resistivity was measured using ASTM D 257. Permeability in cu ft./sq. ft./min. was measured using the Fraiser method as outlined in ASTM D 737. The results are set forth in Table 1:

TABLE 1

| | | Permeability (air flow) |
|---|---|---|
| | Resistivity (ohm-cm) | (cu. ft./sq. ft./min.) |
| A. Spectracorp. 2050A- | 1.25 | 131.2 |
| 2020 | | |
| B. Toray-060 | 1.0 | 51.9 |
| C. Toray-120 | 0.82 | 26.8 |
| D. Carbon cloth, knit | 0.51 | 205.0 |
| weave | | |
| E. Nickel metal foam | <0.1 | 712.0 |
| F. Example 4 foam | 0.52 | 150.0 |
| G. Carbon cloth, plain | 0.22 | 120.4 |
| weave (0.65 mm) | | |
| H. Carbon cloth, satin | 1.0 | 32.8 |
| weave (1.0 mm) | | |

The lower the resistivity the better the expected performance of the material as a gas diffusion layer in PEM fuel cells. Higher resistivity leads to greater parasitic power losses and heat generation.

In contrast, the higher the gas permeability, the better the expected performance of the material as a gas diffusion layer in PEM fuel cells. Higher gas permeability means better flow of fuel (hydrogen gas) to the anode and better flow of oxygen to, and water vapor and carbon dioxide away from the cathode in the fuel cell. As shown in Table 1, the Example 4 metal coated foam of the invention had higher gas permeability and lower resistivity than the prior art materials, other than carbon cloth. However, the Example 4 metal coated foam may be produced for substantially lower cost than carbon cloth.

Referring to FIG. 5, the graph shows the stress-strain hysteresis for nickel metal foam (prior art) and for the Example 4 metal coated foam according to the invention. One inch diameter samples of equivalent thickness (0.25 inch) were compressed and the load was measured. The metal coated foam (Example 4) took a load of 65 pounds for a 50 percent compression. The nickel metal foam took a load of 140 pounds for a 50 percent compression. The nickel metal foam did not measurably recover after the load was removed, whereas the metal coated foam according to the invention recovered to 90% of its original thickness immediately. Thus, the nickel metal foam of the prior art has greater stiffness and malleability, such that it bends or creases in response to an applied force and remains so bent or creased. By contrast, the flexible metal coated foam of the invention rebounds after bending. This characteristic makes the metal coated foam easier to handle and install in fuel cell applications. Such coated foam may be formed in a sheet and rolled over a roller. The foam according to the invention maintains better contact with a bipolar plate, separator or PEM at a lower force, which leads to greater fuel cell efficiency, easier assembly and possibly a lighter weight design.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A gas diffusion layer for a fuel cell, comprising a porous material, which porous material comprises a solid matrix and interconnected pores or interstices therethrough that has at least one external surface and internal surfaces, wherein at least a portion of the at least one external surface is coated with one or more layers of at least one electrically conductive material.

2. The gas diffusion layer of claim 1, wherein the porous material is a porous polymeric material or porous inorganic material.

3. The gas diffusion layer of claim 2, wherein the porous material is a porous polymeric material selected from the group consisting of foams, bundled fibers, matted fibers, needled fibers, woven or nonwoven fibers, and porous polymers made by pressing polymer beads.

4. The gas diffusion layer of claim 3, wherein the porous material is a porous polymeric material selected from the group consisting of foams,bundled fibers, woven or nonwoven fibers, and Porex like materials.

5. The gas diffusion layer of claim 4, wherein the porous material is selected from polyurethane foams, melamine foams, polyvinyl alcohol foams, or nonwoven felts, woven fibers or bundles of fibers made of polyamide, polyethylene, polypropylene, polyester, cellulose, polyacrylonitrile, Rayon and mixtures thereof.

6. The gas diffusion layer of claim 5, wherein the porous material is a foam.

7. The gas diffusion layer of claim 6, wherein the porous material is a polyurethane foam.

8. The gas diffusion layer of claim 7, wherein the porous material is a felted polyurethane foam, reticulated polyurethane foam, or felted reticulated polyurethane foam.

9. The gas diffusion layer of claim 7, wherein the porous material is a polyether polyurethane foam.

10. The gas diffusion layer of claim 6, wherein the porous material is a reticulated polymer foam.

11. The gas diffusion layer of claim 10, wherein the porous material is a reticulated polyurethane foam.

12. The gas diffusion layer of claim 11, wherein the porous material is a flexible reticulated polyurethane foam.

13. The gas diffusion layer of claim 2, wherein the porous material is an inorganic porous material.

14. The gas diffusion layer of claim 13, wherein the inorganic porous material comprises sintered inorganic powders of silica or alumina.

15. The gas diffusion layer of claim 1, wherein the porous material has a pore size in the range of about 5 to about 150 pores per linear inch.

16. The gas diffusion layer of claim 1, wherein the porous material has a density in the range of about 0.5 to about 8.0 pounds per cubic foot.

17. The gas diffusion layer of claim 1, wherein the at least one electrically conductive material is amorphous carbon, graphite or a metal.

18. The gas diffusion layer of claim 17, wherein the at least one electrically conductive material is a substance selected from the group consisting of nickel, gold, platinum, cobalt, chromium, copper, indium, aluminum, titanium, zirconium, alloys of such metals, salts of such metals, and mixtures thereof.

19. The gas diffusion layer of claim 18, wherein the at least one electrically conductive material is nickel.

20. The gas diffusion layer of claim 17, wherein the at least one electrically conductive material is amorphous carbon or graphite.

21. The gas diffusion layer of claim 1, wherein the at least one electrically conductive material has a resistivity less than 20 ohm-cm.

22. The gas diffusion layer of claim 21, wherein the at least one electrically conductive material has a resistivity less than 1 ohm-cm.

23. The gas diffusion layer of claim 1, wherein the one or more layers of the at least one electrically conductive material has a total thickness of no more than about 500 microns.

24. The gas diffusion layer of claim 23, wherein the one or more layers of the at least one electrically conductive material has a total thickness of no more than about 100 microns.

25. The gas diffusion layer of claim 24, wherein the one or more layers of the at least one electrically conductive material has a total thickness of no more than about 10 microns.

26. The gas diffusion layer of claim 1, wherein the one or more layers of the at least one electrically conductive material has a total thickness of about 1 to about 500 microns.

27. The gas diffusion layer of claim 26, wherein the one or more layers of the at least one electrically conductive material has a total thickness of about 5 to about 100 microns.

28. The gas diffusion layer of claim 27, wherein the one or more layers of the at least one electrically conductive material has a total thickness of about 10 to about 50 microns.

29. The gas diffusion layer of claim 1, wherein the at least a portion of at least one surface is coated with the at least one electrically conductive material by a coating method selected from electroplating, electroless plating, plasma vapor deposition, sputtering, arc forming, and a dip and nip coating process.

30. The gas diffusion layer of claim 29, wherein the at least a portion of the at least a surface is coated by dipping the porous material into or painting the at least a portion of the at least a surface with a paint or slurry comprising particles of the at least one electrically conductive material dispersed in a liquid binder.

31. The gas diffusion layer of claim 1, wherein the porous material further comprises having at least portions of some of the internal surfaces coated with one or more layers of at least one electrically conductive material, with the coated portions of the internal surfaces and the coated portion of the at least one external surface together forming an electrically conductive pathway, wherein the at least one electrically conductive material coating the at least portions of some of the internal surfaces is the same as or different from the at least one electrically conductive material coating the at least a portion of the at least one external surface.

32. The gas diffusion layer of claim 31, wherein the at least one electrically conductive material coating the at least portions of some of the internal surfaces is the same as the at least one electrically conductive material coating the at least a portion of the at least one external surface.

33. The gas diffusion layer of claim 1, wherein
(i) the porous material has at least first and second external surfaces, and
(ii) at least a portion of the first external surface and at least a portion of the second external surface are coated with one or more layers of at least one electrically conductive material, with the coated portions of the first and second external surfaces together forming an electrically conductive pathway, wherein the at least one electrically conductive material coating the at least a portion of the first external surface is the same as or different from the at least one electrically conductive material coating the at least a portion of the second external surface.

34. The gas diffusion layer of claim 33, wherein the at least one electrically conductive material coating the at least a portion of the first external surface is the same as the at least one electrically conductive material coating the at least a portion of the second external surface.

35. The gas diffusion layer of claim 33, wherein at least portions of some of the internal surfaces of the porous material are coated with one or more layers of at least one electrically conductive material, with the coated portions of the first and second external surfaces and the coated portions of some of the internal surfaces together forming an electrically conductive pathway, wherein the at least one electrically conductive material coating the at least portions of some of the internal surfaces, the at least one electrically conductive material coating the at least a portion of the first external surface and the at least one electrically conductive material coating the at least a portion of the second external surface are the same or different.

36. The gas diffusion layer of claim 35, wherein the at least one electrically conductive material coating the at least portions of some of the internal surfaces, the at least one electrically conductive material coating the at least a portion of the first external surface and the at least one electrically conductive material coating the at least a portion of the second external surface are the same.

37. The gas diffusion layer of claim 1 in the shape of a substantially rectangular or square sheet having six external surfaces: first and second major external surfaces opposite to each other and first, second, third and fourth minor external surfaces, wherein a portion of at least one of the major external surfaces is coated, with one or more layers of at least one electrically conductive material.

38. The gas diffusion layer of claim 37, wherein at least a portion of at least the first major external surface and a portion of at least the first minor external surface are coated with one or more layers of at least one electrically conductive material, with the coated portion of the first major external surface and the coated portion of the first minor external surface together forming a electrically conductive pathway, wherein the at least one electrically conductive material coating the first major external surface and that coating the first minor external surface are the same or different.

39. The gas diffusion layer of claim 38, wherein the at least one electrically conductive material coating the first major external surface and that coating the first minor external surface are the same.

40. The gas diffusion layer of claim 38, wherein at least a portion of at least the first major external surface, at least a portion of at least the second major external surface and at least a portion of the first minor external surface are coated with one or more layers of at least one electrically conductive material, with the coated portion of the first major external surface, the coated portion of the second major external surface and the coated portion of the first minor external surface together forming a electrically conductive pathway, wherein the at least one electrically conductive material coating the first major external surface, that coating the second major external surface and that coating the first minor external surface are the same or different.

41. The gas diffusion layer of claim 37, wherein at least a portion of at least the first major external surface, at least a portion of at least the second major external surface and at least portions of some of the internal surfaces are coated with one or more layers of at least one electrically conductive material, with the coated portion of the first major external surface, the coated portion of the second major external surface: and the coated portions of some of the internal surfaces together forming a electrically conductive pathway, wherein the at least one electrically conductive material coating the first major external surface, the at least one electrically conductive material coating the second major external surface and the at least one electrically conductive material coating at least some of the external surfaces are the same or different.

42. The gas diffusion layer of claim 41, wherein the at least one electrically conductive material coating the first major external surface, the at least one electrically conductive material coating the second major external surface and the at least one electrically conductive material coating at least some of the external surfaces are the same.

43. A combination comprising the gas diffusion layer of claim 1 adjacent to an electrode, wherein said electrode comprises a catalyst suitable for oxidation/reduction carried out in a fuel cell, and wherein the portion of the at least one external surface coated with the at least one electrically conductive-material is adjacent to the electrode.

44. A combination comprising the gas diffusion layer of claim 2 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

45. A combination comprising the gas diffusion layer of claim 3 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

46. A combination comprising the gas diffusion layer of claim 4 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

47. A combination comprising the gas diffusion layer of claim 5 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

48. A combination comprising the gas diffusion layer of claim 6 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

49. A combination comprising the gas diffusion layer of claim 7 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

50. A combination comprising the gas diffusion layer of claim 8 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

51. A combination comprising the gas diffusion layer of claim 9 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

52. A combination comprising the gas diffusion layer of claim 10 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

53. A combination comprising the gas diffusion layer of claim 11 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

54. A combination comprising the gas diffusion layer of claim 12 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

55. A combination comprising the gas diffusion layer of claim 13 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

56. A combination comprising the gas diffusion layer of claim 14 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

57. A combination comprising the gas diffusion layer of claim 15 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

58. A combination comprising the gas diffusion layer of claim 16 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

59. A combination comprising the gas diffusion layer of claim 17 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

60. A combination comprising the gas diffusion layer of claim 18 in contact adjacent to an electrode, wherein said electrode comprises a catalyst suitable for oxidation/reduction carried out in a fuel cell, and wherein the portion of the at least one external surface coated with the at least one electrically conductive material is adjacent to the electrode.

61. A combination comprising the gas diffusion layer of claim 19 adjacent to an electrode, wherein said electrode comprises a catalyst suitable for oxidation/reduction carried out in a fuel cell, and wherein the portion of the at least one to external surface coated with the at least one electrically conductive material is adjacent to the electrode.

62. A combination comprising the gas diffusion layer of claim 20 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

63. A combination comprising the gas diffusion layer of claim 21 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

64. A combination comprising the gas diffusion layer of claim 22 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

65. A combination comprising the gas diffusion layer of claim 23 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

66. A combination comprising the gas diffusion layer of claim 24 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

67. A combination comprising the gas diffusion layer of claim 25 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

68. A combination comprising the gas diffusion layer of claim 26 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

69. A combination comprising the gas diffusion layer of claim 27 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

70. A combination comprising the gas diffusion layer of claim 28 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

71. A combination comprising the gas diffusion layer of claim 29 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

72. A combination comprising the gas diffusion layer of claim 30 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

73. A combination comprising the gas diffusion layer of claim 31 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

74. A combination comprising the gas diffusion layer of claim 32 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

75. A combination comprising the gas diffusion layer of claim 33 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

76. A combination comprising the gas diffusion layer of claim 34 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

77. A combination comprising the gas diffusion layer of claim 35 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

78. A combination comprising the gas diffusion layer of claim 36 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

79. A combination comprising the gas diffusion layer of claim 37 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

80. A combination comprising the gas diffusion layer of claim 38 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

81. A combination comprising the gas diffusion layer of claim 39 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

82. A combination comprising the gas diffusion layer of claim 40 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

83. A combination comprising the gas diffusion layer of claim 41 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

84. A combination comprising the gas diffusion layer of claim 42 adjacent to an electrode, wherein said electrode comprises a catalyst suitable for oxidation/reduction carried out in a fuel cell, and wherein the portion of the at least one external surface coated with the at least one electrically conductive material is adjacent to the electrode.

85. A fuel cell comprising
a cathode;
an anode;
a solid polymer electrolyte membrane sandwiched between the cathode and anode;
a gas diffusion layer of claim 1 disposed adjacent to the cathode or anode on a surface opposite the polymer electrolyte membrane, wherein the portion of the at least one external surface coated with the at least one electrically conductive material is adjacent to the cathode or anode.

86. The fuel cell of claim 85, wherein the gas diffusion layer is disposed adjacent to the cathode.

87. The fuel cell of claim 85, wherein the gas diffusion layer is disposed adjacent to the anode.

88. The fuel cell of claim 86, further comprising a second gas diffusion layer of claim 1 disposed adjacent to the anode.

89. The fuel cell of claim 85, wherein the gas diffusion layer is the gas diffusion layer of claim 2.

90. The fuel cell of claim 85, wherein the gas diffusion layer is the gas diffusion layer of claim 3.

91. The fuel cell of claim 85, wherein the gas diffusion layer is the gas diffusion layer of claim 4.

92. The fuel cell of claim 85, wherein the gas diffusion layer is the gas diffusion layer of claim 5.

93. The fuel cell of claim 85, wherein the gas diffusion layer is the gas diffusion layer of claim 6.

94. The fuel cell of claim 85, wherein the gas diffusion layer is the gas diffusion layer of claim 7.

95. The fuel cell of claim 85, wherein the gas diffusion layer is the gas diffusion layer of claim 8.

96. The fuel cell of claim 85, wherein the gas diffusion layer is the gas diffusion layer of claim 9.

97. The fuel cell of claim 85, wherein the gas diffusion layer is the gas diffusion layer of claim 10.

98. The fuel cell of claim 85, wherein the gas diffusion layer is the gas diffusion layer of claim 11.

99. The fuel cell of claim 85, wherein the gas diffusion layer is the gas diffusion layer of claim 12.

100. The fuel cell of claim 85, wherein the-gas diffusion layer is the gas diffusion layer of claim 13.

101. The fuel cell of claim 85, wherein the gas diffusion layer is the gas diffusion layer of claim 14.

102. The fuel cell of claim 85, wherein the gas diffusion layer is the gas diffusion layer of claim 15.

103. The fuel cell of claim 85, wherein the gas diffusion layer is the gas diffusion layer of claim 16.

104. The fuel cell of claim 85, wherein the gas diffusion layer is the gas diffusion layer of claim 17.

105. The fuel cell of claim 85, wherein the gas diffusion layer is the gas diffusion layer of claim 18.

106. The fuel cell of claim 85, wherein the gas diffusion layer is the gas diffusion layer of claim 19.

107. The fuel cell of claim 85, wherein the gas diffusion layer is the gas diffusion layer of claim 20.

108. The fuel cell of claim 85, wherein the gas diffusion layer is the gas diffusion layer of claim 21.

109. The fuel cell of claim 85, wherein the gas diffusion layer is the gas diffusion layer of claim 22.

110. The fuel cell of claim 85, wherein the gas diffusion layer is the gas diffusion layer of claim 23.

111. The fuel cell of claim 85, wherein the gas diffusion layer is the gas diffusion layer of claim 24.

112. The fuel cell of claim 85, wherein the gas diffusion layer is the gas diffusion layer of claim 25.

113. The fuel cell of claim 85, wherein the gas diffusion layer is the gas diffusion layer of claim 26.

114. The fuel cell of claim 85, wherein the gas diffusion layer is the gas diffusion layer of claim 27.

115. The fuel cell of claim 85, wherein the gas diffusion layer is the gas diffusion layer of claim 28.

116. The fuel cell of claim 85, wherein the gas diffusion layer is the gas diffusion layer of claim 29.

117. The fuel cell of claim 85, wherein the gas diffusion layer is the gas diffusion layer of claim 30.

118. The fuel cell of claim 85, wherein the gas diffusion layer is the gas diffusion layer of claim 31.

119. The fuel cell of claim 85, wherein the gas diffusion layer is the gas diffusion layer of claim 32.

120. The fuel cell of claim 85, wherein the gas diffusion layer is the gas diffusion layer of claim 33.

121. The fuel cell of claim 85, wherein the gas diffusion layer is the gas diffusion layer of claim 34.

122. The fuel cell of claim 85, wherein the gas diffusion layer is the gas diffusion layer of claim 35.

123. The fuel cell of claim 85, wherein the gas diffusion layer is the gas diffusion layer of claim 36.

124. The fuel cell of claim 85, wherein the gas diffusion layer is the gas diffusion layer of claim 37.

125. The fuel cell of claim 85, wherein the gas diffusion layer is the gas diffusion layer of claim 38.

126. The fuel cell of claim 85, wherein the gas diffusion layer is the gas diffusion layer of claim 39.

127. The fuel cell of claim 85, wherein the gas diffusion layer is the gas diffusion layer of claim 40.

128. The fuel cell of claim 85, wherein the gas diffusion layer is the gas diffusion layer of claim 41.

129. The fuel cell of claim 85, wherein the gas diffusion layer is the gas diffusion layer of claim 42.

130. A combination comprising the gas diffusion layer of claim 1 adjacent to a substantially nonporous, electrically conductive separator.

131. A combination comprising the gas diffusion layer of claim 2 adjacent to a substantially nonporous, electrically conductive separator.

132. A combination comprising the gas diffusion layer of claim 3 adjacent to a substantially nonporous, electrically conductive separator.

133. A combination comprising the gas diffusion layer of claim 4 adjacent to a substantially nonporous, electrically conductive separator.

134. A combination comprising the gas diffusion layer of claim 5 adjacent to a substantially nonporous, electrically conductive separator.

135. A combination comprising the gas diffusion layer of claim 6 adjacent to a substantially nonporous, electrically conductive separator.

136. A combination comprising the gas diffusion layer of claim 7 adjacent to a substantially nonporous, electrically conductive separator.

137. A combination comprising the gas diffusion layer of claim 8 adjacent to a substantially nonporous, electrically conductive separator.

138. A combination comprising the gas diffusion layer of claim 9 adjacent to a substantially nonporous, electrically conductive separator.

139. A combination comprising the gas diffusion layer of claim 10 adjacent to a substantially nonporous, electrically conductive separator.

140. A combination comprising the gas diffusion layer of claim 11 adjacent to a substantially nonporous, electrically conductive separator.

141. A combination comprising the gas diffusion layer of claim 12 adjacent to a substantially nonporous, electrically conductive separator.

142. A combination comprising the gas diffusion layer of claim 15 adjacent to a substantially nonporous, electrically conductive separator.

143. A combination comprising the gas diffusion layer of claim 16 adjacent to a substantially nonporous, electrically conductive separator.

144. A combination comprising the gas diffusion layer of claim 17 adjacent to a substantially nonporous, electrically conductive separator.

145. A combination comprising the gas diffusion layer of claim 18 adjacent to a substantially nonporous, electrically conductive separator.

146. A combination comprising the gas diffusion layer of claim 22 adjacent to a substantially nonporous, electrically conductive separator.

147. A combination comprising the gas diffusion layer of claim 31 adjacent to a substantially nonporous, electrically conductive separator.

148. A combination comprising the gas diffusion layer of claim 33 adjacent to a substantially nonporous, electrically conductive separator.

149. A combination comprising the gas diffusion layer of claim 35 adjacent to a substantially nonporous, electrically conductive separator.

150. A combination comprising the gas diffusion layer of claim 37 adjacent to a substantially nonporous, electrically conductive separator.

151. A combination comprising the gas diffusion layer of claim 38 adjacent to a substantially nonporous, electrically conductive separator.

152. A combination comprising the gas diffusion layer of claim 40 adjacent to a substantially nonporous, electrically conductive separator.

153. A combination comprising the gas diffusion layer of claim 41 adjacent to a substantially nonporous, electrically conductive separator.

154. The combination of claim 130, further comprising an electrode suitable for a fuel cell adjacent to the gas diffusion layer.

155. A gas diffusion layer for a fuel cell, comprising:
a flexible reticulated polyurethane foam, said foam comprising a network of strands forming interconnected pores therebetween, wherein at least one portion of the network at at least one external surface of said foam is coated with at least one layer of at least one electrically conductive material.

156. The gas diffusion layer of claim 155, wherein the foam has a pore size in the range of about 5 to about 150 pores per linear inch.

157. The gas diffusion layer of claim 155, wherein the foam has a density in the range of about 0.5 to about 8.0 pounds per cubic foot.

158. The gas diffusion layer of claim 155, wherein the polyurethane foam is a polyether polyurethane foam.
